(19) United States
(12) Patent Application Publication
(10) Pub. No.: US 2008/0005500 A1
(43) Pub. Date: Jan. 3, 2008

(54) Method, system, and apparatus for accessing core resources in a multicore environment

(76) Inventors: Mansoor Ahamed Basheer Ahamed, Bangalore (IN); Kiran S. Panesar, Bellandur (IN); Padmashree K. Apparao, Portland, OR (US)

Correspondence Address: BUCKLEY, MASCHOFF & TALWALKAR LLC, 50 LOCUST AVENUE, NEW CANAAN, CT, 06840, US

(21) Appl. No.: 11/477,181

(22) Filed: Jun. 28, 2006

(51) Int. Cl. G06F 13/00

(52) U.S. Cl. 711/154

(57) ABSTRACT

A method, apparatus, and system, the method including, in some embodiments, updating a data structure of a second processor with an internal resource base address register (BAR) of a first processor, requesting access to the internal resource of the first processor by the second processor based on the updated data structure of the second processor, and providing, in response to the request of the second processor, access to the internal resource of the first processor to the second processor.

### BACKGROUND

A device, system, platform, or operating environment may be partitioned into a number of “sequestered” environments. The sequestered environments may provide, for example, improved security, reliability, and efficient use of the device, system, platform, or operating environment resources.

A device, system, platform, or operating environment may include more than one processor or a processor having more than one core (i.e., a multicore processor). The secure, reliable, and efficient operation of a device, system, platform, or operating environment may use, at least in part, knowledge of an internal resource of the processors.

However, some internal resources and information associated with the internal resources of a processor may not be accessible to other processors and devices of a given device, system, platform, or operating environment.

### BRIEF DESCRIPTION OF THE DRAWINGS

FIG. 1 is an exemplary illustration of an apparatus, in accordance with some embodiments herein;

FIG. 2 is an exemplary depiction of a memory, in accordance with some embodiments herein;

FIG. 3 is an exemplary flow diagram of a process, in accordance with some embodiments herein;

FIG. 4 is an exemplary timing sequence of a process, in accordance with some embodiments herein;

FIG. 5 is an exemplary illustration of an apparatus, in accordance with some embodiments herein;

FIG. 6 is an exemplary flow diagram of a process, in accordance with some embodiments herein; and

FIG. 7 is an exemplary depiction of a system, according to some embodiments herein.

### DETAILED DESCRIPTION

The several embodiments described herein are solely for the purpose of illustration. Embodiments may include any currently or hereafter-known versions of the elements described herein. Therefore, persons skilled in the art will recognize from this description that other embodiments may be practiced with various modifications and alterations.

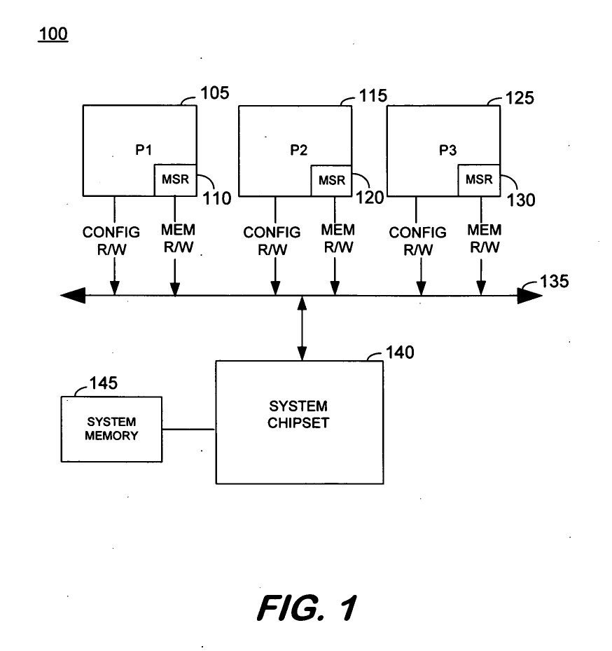

FIG. 1 is an exemplary depiction of an apparatus 100, in accordance with some embodiments herein. It should be appreciated that apparatus 100 may include, more, different, or fewer components and functionality than those depicted in FIG. 1, without departing from the scope of the various embodiments herein.

Apparatus 100 includes three processors 105 (P1), 115 (P2), and 125 (P3). Processors 105, 115, 125 are shown to illustrate the multiple cores included in apparatus 100. Apparatus 100 may include any multiplicity of processors. Processors 105, 115, 125 may each have at least one internal resource associated therewith. An internal resource of the processors may include a bank of reporting registers. The reporting registers may facilitate monitoring machine errors, recording machine check errors, and other processor aspects, including a status of various processor operations and attributes. For example, an operating state of the processor may be recorded in a processor internal resource register.

In some embodiments, the internal resources of a processor are not visible or accessible to other processors, devices, and systems. For example, an internal resource associated with processor P1 may be visible only to the processor P1 and not visible or accessible to processors P2 and P3. Each of the internal resources, such as a bank of registers, may be associated with a specific hardware unit of the associated processor. Such internal resources are referred to herein as a model specific register (MSR).

It may desirable for a first (second) processor to access an internal resource of a second (first) processor, wherein the internal resource for which access is desired may not be directly accessible by the processor requesting the access. Referring again to FIG. 1, processor 105 includes MSR 110, processor 115 includes MSR 120, and processor 125 includes MSR 130. Apparatus 100 includes a system memory 145 that is connected to system chipset 140. A front side bus (FSB) 135 provides a connection to system chipset 140 and system memory 145 from processors 105, 115, 125.

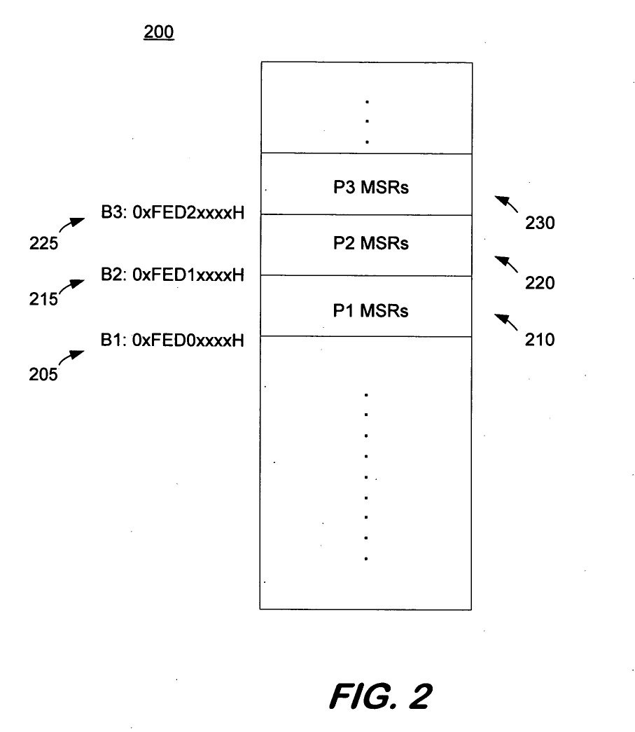

FIG. 2 is an exemplary representation of a memory, generally represented by numeral 200. Memory 200 may be a system memory associated with an apparatus, device, or system such as, for example, the system memory shown in FIG. 1. Memory 200 may be arranged to facilitate memory mapping of internal resources of the multiple processors of the apparatus, such as, for example, a MSR that may be used to setup machine checking, recording of machine check errors, etc.

In some embodiments, the internal resources of the multiple processors of an apparatus or system may each only be visible and accessible to the particular processor associated with the internal resource. In some embodiments, a memory of an apparatus or system having multiple processors may be accessible or visible to a plurality of the processors, including a sequestered environment. In accordance with some embodiments herein, the internal resources having limited visibility and accessibility by processors other than the one associated with the internal resource may be mapped to a memory accessible to a plurality to the processors. Memory 200 may be at least partially partitioned or reserved for the mapping of processor internal resources (e.g., MSRs) of at least one processor.

For example, processor P1 MSRs are mapped in memory 200 starting at a base address B1 (205) and extending over a range 210 (B1+offsets). In a similar manner, processor P2 MSRs are mapped in memory 200 starting at a base address B2 (215) that extends over a range 220 (B2+offsets) and processor P3 MSRs are mapped in memory 200 starting at a base address B3 (225) and extending over a range 230 (B3+offsets).

A bank of machine check MSRs of processor P1 (105) may be mapped at base address B1 (205). In a similar manner, a bank of machine check MSRs of processor P2 (115) may be mapped at base address B2 (215), and a bank of machine check MSRs of processor P3 (125) may be mapped at base address B3 (225). As illustrated, the MSRs associated with P1 are mapped to memory range 210, including B1 plus an offset. In a like manner, the MSRs associated with P2 are mapped to memory range 220, including B2 plus an offset, and the MSRs associated with P3 are mapped to memory range 230, including B3 plus an offset.

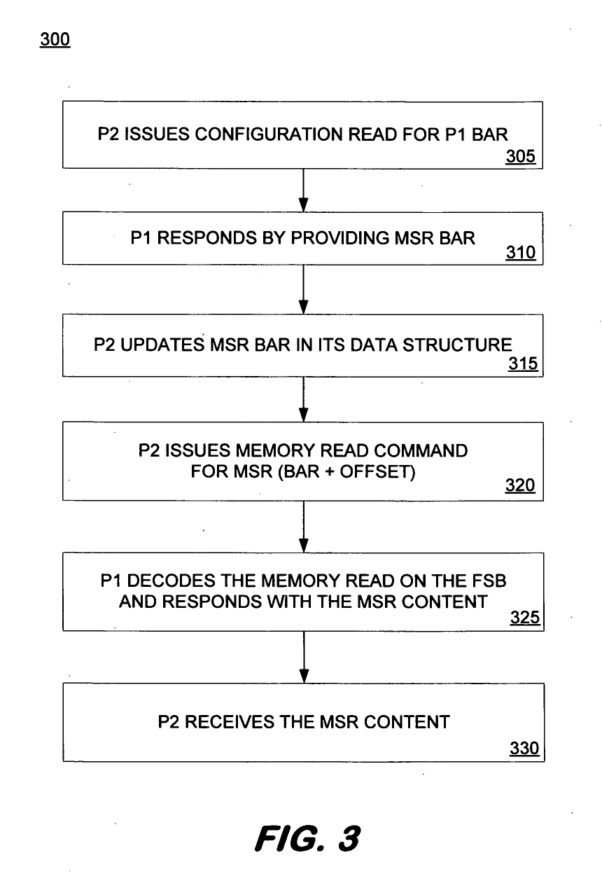

FIG. 3 is an exemplary flow diagram of a process 300, in accordance with some embodiments herein. In some embodiments, process 300 may used in conjunction with the apparatus of FIG. 1. Processor 300 is facilitated by the mapping of processor MSRs (internal resources) to a memory accessible to each of a plurality of processors. Process 300 provides a mechanism for one processor (e.g., P2) to access an internal resource of another processor (e.g., P1).

At operation 305, a processor P2 issues a configuration read command for a base address register (BAR) of another processor P1. The configuration read command allows P2 to ascertain the arrangement of P1 BAR data structure. It should be appreciated that the “configuration read” command may be replaced by another command or process that provides similar functionality. The particular command or process may vary depending on a device or system context or operational environment.

At operation 310, processor P1 responds to the configuration read command by providing the MSR BAR for P1. At operation 315, processor P2 updates MSR BAR in its data structure based on the response provided by P1.

At operation 320, P2 issues a memory read command (or other command having similar functionality) for the desired P1 MSR address. P2 is able to request the proper read address based on its updated data structure. The read request may generally include the requested BAR+offset.

At operation 325, processor P1 decodes the memory read request and responds with the MSR content associated with the requested memory address (BAR+offset). The specific mechanism used for P1 to respond to the read request may vary depending of the context of a device or system. For example, in a device or system including a FSB, the read request is facilitated by a memory read while in a CSI (Configurable System Interconnect bus) based system other mechanisms may be used.

At operation 330, processor P2 that made the request is provided with the MSR content. In this manner, P2 is provided access to a MSR of another processor, P1.

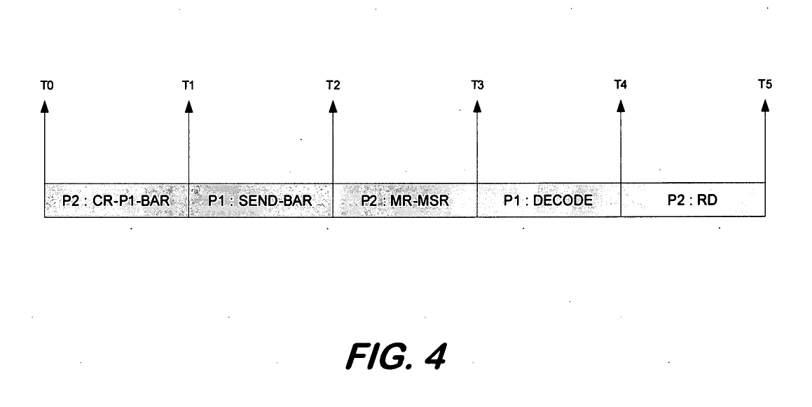

FIG. 4 is an exemplary timing sequence of a process, in accordance with some embodiments herein. The timing of FIG. 4 may correspond to process 300. Regarding the timing diagrams herein, the following apply:

CR: Configuration Read

MR: Memory Read

RD: receive Data

BAR: Base Address Register

At time T0-T1, P2 issues the configuration read for P1's MSR BAR. At T1-T2, P1 provides or sends the MSR BAR to P2. During time T2-T3, P2 issues a memory read request for a specific address based on the configuration of P1's MSR BAR, for example BAR+some offset. At T3-T4, P1 decodes the memory read request and places the data associated with the requested address (BAR+some offset) in memory. At T4-T5, processor receives the data associated with the requested read.

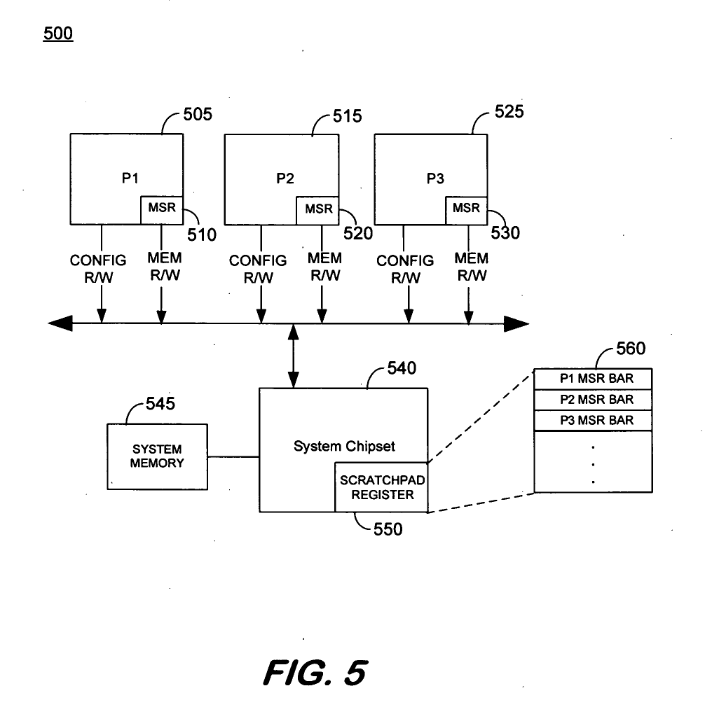

FIG. 5 is an exemplary depiction of an apparatus 500, in accordance with some embodiments herein. It should be appreciated that apparatus 500 may include, more, different, or fewer components and functionality than those depicted in FIG. 5, without departing from the scope of the various embodiments herein.

Apparatus 500 includes three processors 505 (P1), 515 (P2), and 525 (P3). Processors 505, 515, 525 are shown to illustrate the multiple cores included in apparatus 500. Apparatus 500 may include any multiplicity of processors. Processors 505, 515, 525 may each have at least one internal resource associated therewith. An internal resource of the processors may include a bank of reporting registers. The reporting registers may facilitate monitoring machine errors, recording machine check errors, and other processor aspects, including a status of various processor operations and attributes.

Apparatus 500 further includes MSR 510 associated with processor 505, processor 515 includes MSR 520, and processor 525 includes MSR 530. Apparatus 500 includes a system memory 545 that is connected to system chipset 540. FSB 535 provides a connection to system chipset 140 and system memory 545 from processors 505, 515, 525.

In some embodiments, It may desirable for a first (second) processor to access an internal resource of a second (first) processor, wherein the internal resource for which access is desired may not be directly accessible by the processor requesting the access. To facilitate such desired functionality, system chipset 540 is provided with a scratchpad register 550. Scratchpad register 550 facilitates exchanging the BAR from one processor to another processor so that internal resources may be accessed by processors other than the processor associated with the internal resource. Details of scratchpad register 550 are shown at 560.

An interrupt may be issued from the requesting processor to the other processor. For example, processor P2 may request the P1 BAR B1 by issuing an inter-processor interrupt, to which P1 responds by writing B1 to a scratchpad register 550 (or another designated, predetermined location). That is, the BAR for a particular processor is written to scratchpad register 550 when a request is made.

In some embodiments, system chipset 540 may contain a BAR registers for a predetermined number of processor connected to system chipset 540. In some embodiments, system chipset 540 may contain a BAR registers for each of the processors connected thereto. A mechanism such as, for example, platform firmware, may place the BARs for each processor in the scratchpad register upon initialization of each processor. In this manner, the BAR for a particular processor is written to scratchpad register 550 during an initialization process.

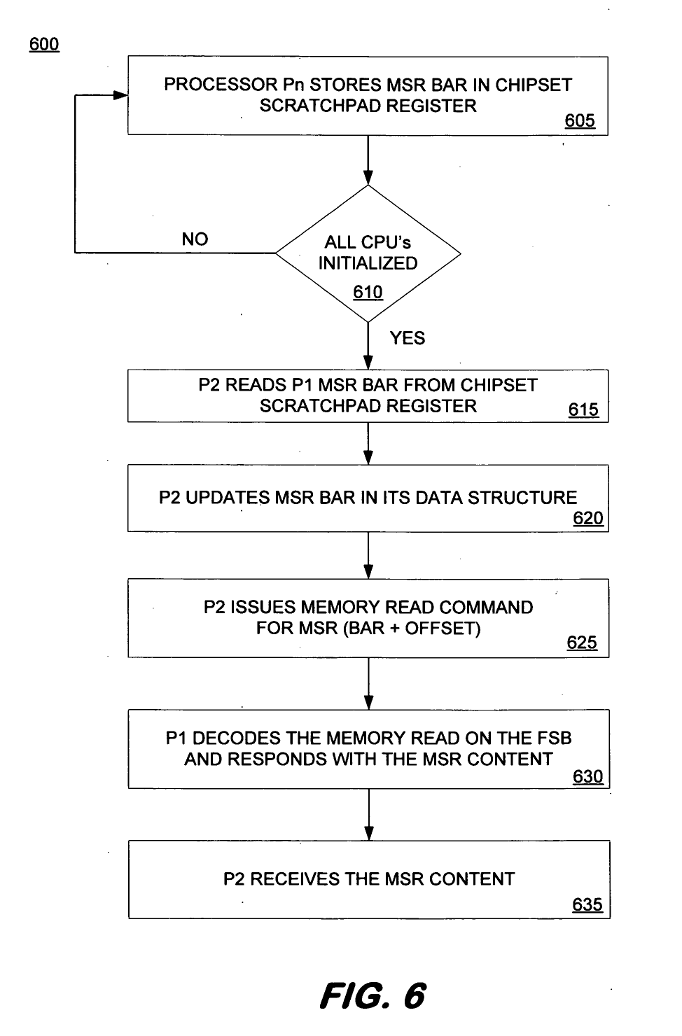

FIG. 6 is an exemplary flow diagram of a process 600, in accordance with some embodiments herein. In some embodiments, process 600 may used in conjunction with the apparatus of FIG. 5. Processor 600 is facilitated by the mapping of processor MSRs (internal resources) to a memory accessible to each of a plurality of processors and a scratchpad registers. Process 600 provides a mechanism for one processor (e.g., P2) to access an internal resource of another processor (e.g., P1).

At operation 605 and 610, an initialization process is depicted wherein the MSR for each of the processors of a device or system are written to the scratchpad register. When a determination is made that the initialization process is complete, process 600 proceeds to operation 615.

At operation 615, a processor P2 reads P1 MSR BAR from the scratchpad register. At operation 620, processor P2 updates MSR BAR in its data structure based on the MSR BAR retrieved from the scratchpad register.

At operation 625, P2 issues a memory read command (or other command having similar functionality) for the desired P1 MSR address. P2 is able to request the proper read address based on its updated data structure. The read request may generally include the requested BAR+offset.

At operation 630, processor P1 decodes the memory read request and responds with the MSR content associated with the requested memory address (BAR+offset). The specific mechanism used for P1 to respond to the read request may vary depending of the context of a device or system.

At operation 635, processor P2 that made the request is provided with the MSR content. In this manner, one processor (e.g., P2) is provided access to a MSR of another processor (e.g., P1).

It is noted that in contrast to process 300, the requesting processor, P2, does not request and obtain the P1 BAR (B1) from processor P1. Accordingly, an efficiency may be gained by the use of process 600.

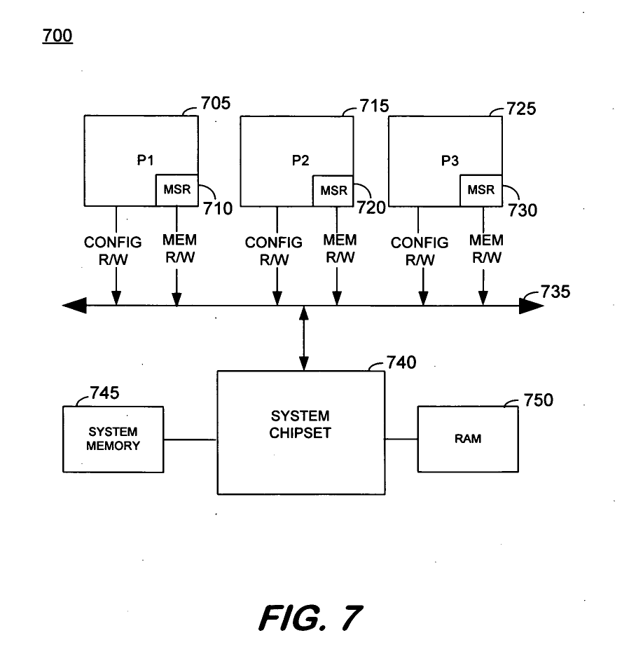

FIG. 7 is an exemplary depiction of an apparatus 700, in accordance with some embodiments herein. It should be appreciated that apparatus 700 may include, more, different, or fewer components and functionality than those depicted in FIG. 7, without departing from the scope of the various embodiments herein.

System 700 includes, for example, three processors 705 (P1), 715 (P2), and 725 (P3). System 700 may include any multiplicity of processors. Processors 705, 715, 725 may each have at least one internal resource associated therewith. An internal resource of the processors may include a bank of reporting registers. The reporting registers may facilitate monitoring machine errors, recording machine check errors, and other processor aspects, including a status of various processor operations and attributes. System 700 also includes MSR 710 associated with processor 705, MSR 720 associated with processor 715, and MSR 730 associated with processor 725. Apparatus 700 further includes system memory 745 and a memory 750 (a random access memory, RAM, module) that is connected to system chipset 540. FSB 735 provides a connection to system chipset 740 from processors 705, 715, 725.

In some embodiments, system 700 may be used to carry out the processes disclosed herein.

Memory 750 may comprise any type of memory for storing data, including but not limited to a Single Data Rate Random Access Memory, a Double Data Rate Random Access Memory, or a Programmable Read Only Memory.

It should be appreciated that other systems, devices, and functionalities may be included in system 7, including for example, those that may be included in a desktop or server computing system, and a handheld computing device.

It should be appreciated that the drawings herein are illustrative of various aspects of the embodiments herein, not exhaustive of the present disclosure.

What is claimed is:

1. A method comprising:
updating a data structure of a second processor with an internal resource base address register (BAR) of a first processor;
requesting access to the internal resource of the first processor by the second processor based on the updated data structure of the second processor; and
providing, in response to the request of the second processor, access to the internal resource of the first processor to the second processor.

2. The method of claim 1, further comprising:
issuing, by the second processor, a configuration read for the internal resource BAR of the first processor; and
providing to the second processor, by the first processor, the internal resource BAR of the first processor.

3. The method of claim 1, further comprising:
storing the internal resource BAR of the first and the second processors in a register accessible to both the first and second processors; and
reading, by the second processor, the internal resource of the first processor from the register.

4. The method of claim 3, wherein the register is a chipset scratchpad register.

5. The method of claim 1, wherein an internal resource is only accessible by its respective processor.

6. The method of claim 1, wherein the internal resource is a model specific register.

7. The method of claim 1, wherein the providing comprises the first processor core decoding the request to access to the internal resource thereof by the second processor core.

8. The method of claim 1, wherein the first processor and the second processor each comprise a sequestered environment.

9. The method of claim 1, wherein the information in the internal resource of the first processor core conveys a status of the first processor.

10. The method of claim 9, wherein the information of the first processor core comprises machine check errors.

11. An apparatus comprising:
a first processor having an internal resource associated with the first processor;
a second processor having an internal resource associated with the second processor, wherein the respective internal resources are only accessible by their respective associated processors; and
a controller for enabling execution of instructions that when executed by a machine result in the following:
updating a data structure of the second processor with an internal resource base address register (BAR) of the first processor;
requesting access to the internal resource of the first processor by the second processor based on the updated data structure of the second processor; and
providing, in response to the request of the second processor, access to the internal resource of the first processor to the second processor.

12. The apparatus of claim 11, wherein the controller further enables execution of instructions that when executed by a machine result in the following:
issuing, by the second processor, a configuration read for the internal resource BAR of the first processor; and
providing to the second processor, by the first processor, the internal resource BAR of the first processor.

13. The apparatus of claim 11, wherein the controller further enables execution of instructions that when executed by a machine result in the following:
storing the internal resource BAR of the first and the second processors in a register accessible to both the first and second processors; and
reading, by the second processor, the internal resource of the first processor from the register.

14. The apparatus of claim 13, wherein the register is a chipset scratchpad register.

15. The apparatus of claim 11, wherein the internal resource is a model specific register.

16. The apparatus of claim 1, wherein the controller further enables execution of instructions that when executed by a machine result in the following:
the first processor core decoding the request to access to the internal resource thereof by the second processor core.

17. The apparatus of claim 11, wherein the first processor and the second processor each comprise a sequestered environment.

18. The apparatus of claim 11, wherein the information in the internal resource of the first processor core conveys a status of the first processor.

19. The apparatus of claim 18, wherein the information of the first processor core comprises machine check errors.

20. A system comprising:
a random access memory module;
a first processor having an internal resource associated with the first processor;
a second processor having an internal resource associated with the second processor, wherein the respective internal resources are only accessible by their respective associated processors; and
a controller for enabling execution of instructions that when executed by a machine result in the following:
updating a data structure of the second processor with an internal resource base address register (BAR) of the first processor;
requesting access to the internal resource of the first processor by the second processor based on the updated data structure of the second processor; and
providing, in response to the request of the second processor, access to the internal resource of the first processor to the second processor.

21. The system of claim 20, wherein the memory module is a Double Data Rate Random Access Memory.

22. The system of claim 20, wherein the controller further enables execution of instructions that when executed by a machine result in the following:
issuing, by the second processor, a configuration read for the internal resource BAR of the first processor; and
providing to the second processor, by the first processor, the internal resource BAR of the first processor.

23. The system of claim 20, wherein the controller further enables execution of instructions that when executed by a machine result in the following:
storing the internal resource BAR of the first and the second processors in a register accessible to both the first and second processors; and
reading, by the second processor, the internal resource of the first processor from the register.
